(19) United States
(12) Patent Application Publication
(10) Pub. No.: US 2007/0213987 A1
(43) Pub. Date: Sep. 13, 2007

(54) Codebook-less speech conversion method and system

(75) Inventors: Oytun Turk, Istanbul (TR); Levent Mustafa Arslan, Istanbul (TR); Fred Deutsch, New York, NY (US)

Correspondence Address: PAUL, HASTINGS, JANOFSKY & WALKER LLP, P.O. BOX 919092, SAN DIEGO, CA, 92191-9092, US

(73) Assignee: Voxonic, Inc., New York, NY (US)

(21) Appl. No.: 11/370,682

(22) Filed: Mar. 8, 2006

(51) Int. Cl. G10L 13/06

(52) U.S. Cl. 704/268

(57) ABSTRACT

The conversion of speech can be used to transform an utterance by a source speaker to match the speech characteristic of a target speaker, for applications such as dubbing a motion picture. During a training phase, utterances corresponding to the same sentences by both the target speaker and source speaker are force aligned according to the phonemes within the sentences. A transformation or mapping is trained so that each frame of the source utterances is mapped to a corresponding frame of the target utterance. After the completion of the training phase, a source utterance is divided into frames, which are transformed into target frames. After all target frames are created from the sequence of frames from the source utterance, a target utterance is created having the speech of the source speaker, but with the vocal characteristics of the target speaker.

### BACKGROUND OF THE INVENTION

1. Field of the Invention

The present invention relates generally to the field of speech conversion and more particularly, to a technique in which utterances, i.e., portions of speech, of a person are used to synthesize new speech while maintaining the vocal characteristics of the original person. The technique may be used, for example, in the entertainment field for converting speech spoken in one language into another language while maintaining the original speaker's vocal characteristics.

2. Description of Related Art

In the field of entertainment, after a movie or television program is recorded in one language using feature actors, it is often desirable to insert a new sound track recorded in a second language to allow the movie or television program to be viewed by people conversant in the second language. Typically, this conversion is accomplished by generating a new script in the second language and then using dubbing actors conversant in the second language to perform the new script, thereby generating a second recording of this latter performance and then superimposing the new recording on the movie. This dubbing process is expensive and time consuming as it requires a whole new cast to generate the second recording. Dubbing of a standard 90 minute movie usually takes several weeks. Dubbing is a specialized endeavor and the number of available dubbing actors who are involved in dubbing is relatively small, especially in some of the less popular languages, thereby forcing entertainment studios to use the same dubbing actors over and over again for different movies. As a result, although many movies have different feature actors, the dubbed version of those movies often sounds the same since they use the same dubbing actors.

FIG. 1 illustrates a conventional technique 100 for dubbing an English language movie into Spanish. Particularly, an English-speaking feature actor 105 speaks English sentences 110 based on an English script 130. The sentences 110 are recorded electronically in any convenient form together with sentences uttered by other actors, special sound effects, etc., to form an English language sound track 120, which is distributed to English-speaking audiences. For a Spanish-speaking audience, a second sound track in Spanish is required. In order to generate a Spanish soundtrack, the English script 130 is first translated into a corresponding Spanish script 140. The translation can be performed by a human translator or by a computer using appropriate software, the implementation of which is apparent to one of ordinary skill in the art. The Spanish script 140 is given to a Spanish dubbing actor 155 who then speaks Spanish sentences 150 corresponding to the English sentences 110, while preferably mimicking the dramatic delivery of the feature actor 105. A Spanish audio track 160 is generated and then superimposed, i.e., dubbed, over the English sound track. The resulting movie dubbed in Spanish 170 can then be distributed to Spanish audiences worldwide.

Other applications require an automated technique that transforms, i.e., converts, the speech of one speaker into the speech of another speaker. For example, a speech recognition system may be trained to recognize a specific person's voice or a normalized composite of voices. Speech conversion as a front-end to a speech recognition system allows a new person to effectively utilize the system by converting the new person's speech into the voice that the speech recognition system is adapted to recognize. In a post-processing scenario, speech conversion may be useful to change the output speech of a text-to-speech synthesizer. Speech conversion also is applicable to other applications, such as, speech disguising, dialect modification, foreign-language dubbing to retain the voice of an original actor, and novelty systems such as celebrity voice impersonation, for example, in Karaoke machines.

In conventional systems that convert speech from “source” speech to “target” speech, multiple codebooks are implemented. A codebook is a collection of “phones,” which are units of voice sounds that a person utters. Codebooks for the source speech and the target speech are generated in a training phase. For example, the spoken English word “cat” in the General American dialect comprises three phones [K], [A-E], and [T], and the word “cot” comprises three phones [K], [AA], and [T]. In this example, “cat” and “cot” share the initial and final consonants, but employ different vowels. Codebooks are structured to provide a one-to-one mapping between the phone entries in a source codebook and the phone entries in a target codebook.

In a codebook approach to speech conversion, an input signal from a source speaker is sampled and preprocessed by segmentation into “frames” corresponding to a voice unit. Each frame is matched to the “closest” source codebook entry and then mapped to the corresponding target codebook entry to obtain a phone in the voice of the target speaker. The mapped frames are concatenated to produce speech in the target voice. A disadvantage with this technique is the introduction of artifacts at frame boundaries leading to a rather rough transition across target frames. The artifacts are usually discernible to the average listener, thereby resulting in converted speech that sounds unnatural. Because the variation between the sound of the input voice frame and the closest matching source codebook entry is discarded or not accounted for, the converted speech is generally of low quality.

A common cause for the variation between the sounds in an actual voice and those in a codebook is that spoken sounds differ depending on their position in words. A phoneme is an abstract symbol used to represent a set of similar sounds, whereas a phone is a specific instance of a phoneme, specifically a phone represents the actual waveform that is uttered to account for a phoneme. As a result, a phoneme may have several allophones. For example, the /t/ phoneme has several allophones, i.e., equivalent phones attributed to the same phoneme. At the beginning of a word, as in the general American pronunciation of the word “top,” the /t/ phoneme is an unvoiced, for t is, aspirated, alveolar stop. In an initial cluster with a /s/, as in the word “stop,” it is an unvoiced, for t is, unaspirated, alveolar stop. In the middle of a word between vowels, as in “potter,” it is an alveolar flap. At the end of a word, as in “pot,” it is an unvoiced, lenis, unaspirated, alveolar stop. Although the allophones of a consonant like /t/ are pronounced differently, a codebook with only one entry for the /t/ phoneme will produce only one kind of /t/ sound and, hence, unconvincing output speech. Prosody also accounts for differences in sound, since a consonant or vowel will sound somewhat different depending on whether it is spoken at a higher or lower pitch, more or less rapidly, and with greater or lesser emphasis. The linguistic terms used in the above examples are readily apparent to one of ordinary skill in the art and can be found in a variety of texts on speech processing. See, e.g., Huang et al., Spoken Language Processing, Prentice Hall (2001).

A conventional approach to improve speech conversion quality increases the amount of training data and the number of codebook entries to account for the different allophones of the same phoneme and different prosodic conditions. However, greater codebook sizes lead to increased storage and processing requirements, thereby limiting the number of systems that can implement such. One major disadvantage of modeling the phonemes using codebooks is the need for summarizing each phone by averaging the acoustic features extracted from the speech frames corresponding to that phone. This disadvantage can be overcome by employing even larger codebooks, i.e., including every speech frame in the training database in the codebook. However, as a phone is a collection of consecutive speech frames in time, including all speech frames in the codebook without keeping track of the continuity is not sufficient for modeling this consecutive structure. Even if the consecutive structure is modeled, the transformation algorithm should be able to match the source speaker's speech frames by not only doing a single frame based match but considering the consecutive speech frames. Furthermore, the computing resources required to perform this degree of modeling would make the method prohibitive.

Conventional speech conversion systems also suffer from a loss of quality because they typically perform their codebook mapping in an acoustic space defined by linear predictive coding coefficients. Linear predictive coding (LPC) is an all-pole modeling of voice and hence, does not adequately represent the zeroes in a voice signal, which are more commonly found in nasal and sounds not originating at the glottis. LPC also has difficulties with higher pitched sounds, for example, those found in a woman's voice or child's voice.

A traditional approach to this problem is to have a training phase where input speech training data from source and target speakers are used to formulate a spectral transformation that attempts to map the acoustic space of the source speaker to that of the target speaker. The acoustic space is characterized by a number of possible acoustic features that have been previously studied. Features used for speech transformation include formant frequencies and LPC spectrum coefficients. Generally, a transformation is based on codebook mapping. That is, a one to one correspondence between the spectral codebook entries of the source speaker and the target speaker is developed by some form of supervised vector quantization method. Such methods often face several problems such as artifacts introduced at the boundaries between successive voice frames, limitation on robust estimation of parameters (e.g., formant frequency estimation), or distortion introduced during synthesis of a target voice. Another issue is the transformation of the excitation characteristics in addition to the vocal tract characteristics. The excitation characteristics usually refer to vocal quality of a specific speaker due to his/her physical metabolism at the larynx. Coarseness, softness, loudness, creakiness are examples of different vocal qualities. The excitation characteristics can also be transformed using a similar mathematical method that is used for vocal tract transformation. However, this usually results in unacceptable distortion in the output, although the resulting utterance sounds closer to the target speaker's voice.

A further disadvantage of existing systems is that many media use high quality digital audio tracks with sampling rates of 44 kHz or more. Prior speech conversion schemes are not readily adapted to handle such high sampling rates and accordingly they are not able to provide a high quality sound.

FIG. 2 illustrates a conventional speech conversion system 200 employing a standard codebook. Referring to FIG. 2(a), codebook mapping is first employed. Here, both the source and target voices are divided into discrete frames by respective frame division hardware and/or software 210 and 220, the identification and implementation of which is apparent to one of ordinary skill in the art. Each frame of a source voice is compared against entries in a codebook 225 through a conventional mathematical/statistical technique, the identification and implementation of which is also apparent to one of ordinary skill in the art, in order to map a voice frame to a codebook entry. Each frame of the target voice is similarly compared against entries in the standard codebook 225 so that a mapping from the codebook entry to a target frame can be made. Alternatively, for a given phone or phoneme in the codebook 225, an exemplary frame of the target voice is selected according to predetermined rules.

The accuracy between each source voice frame and a codebook entry is given by a confidence measure, e.g., a statistical measurement of error between the two phones or phoneme. These confidence measures can be tweaked to get a more accurate match by conventional training techniques, the implementation of which is apparent to one of ordinary skill in the art, thereby bringing the matching of source voice frames and codebook entries within an acceptable limit of error.

Referring to FIG. 2(b), in order to convert speech from a source voice to a target voice, the source voice is divided into frames by frame division hardware/software 210. Each source voice frame is then compared against entries in the standard codebook 225 to find the best matching entry in the codebook 225 at hardware/software 230. With an identified entry in the codebook 225, a target frame is generated at hardware/software 240 based on the mapping learned and shown in FIG. 2(a). Frame assembly hardware/software 250 then reassembles the frames into speech associated with the target voice.

U.S. Pat. No. 6,615,174, the entire disclosure of which is incorporated by reference herein, discloses a codebook mapping approach wherein each speech frame is represented by a weighted average of codebook entries. The weights represent a perceptual distance of the speech frame.

FIG. 3 illustrates a conventional speech conversion system 300 employing source and target codebooks. Referring to FIG. 3(a), a source codebook 310 and a target codebook 320 are trained as well as the mapping 325 between the two codebooks. Particularly, a source voice and a target voice stream are each subdivided into frames by frame division hardware/software 210 and 220, respectively. Based on the frames in the source voice, a source codebook 310 is built having an exemplar of each phone. Likewise, a target codebook 320 is built in a similar fashion. Because of the differences in phonemes, one phoneme can be matched to a number of potential allophones. Rather than average the many phones, the best matching phone is selected based on confidence measures, such as spectral distance, f₀ distance, RMS energy distance, and duration difference. This resolution of the one-to-many could also take place in the transformation phase. See, e.g., U.S. patent application Ser. No. 11/271,325, filed Nov. 10, 2005, and entitled “Speech Conversion System and Method,” the entire disclosure of which is incorporated by reference herein.

Referring to FIG. 3(b), during the transformation phase, a source vocal tract is subdivided into frames by frame division hardware/software 210. Using the source codebook 310 developed during the training phase, the best matching phone is found by hardware/software 330. Using the mapping 325 learned in the training phase as well, a corresponding target codebook entry, which equates to a phone in the target voice, is found in the target codebook 320 by hardware/software 340. The final vocal tract is reassembled by reassembly hardware/software 250 from the target codebook entries.

This technique improves upon the previous method utilizing a single standardized codebook in performing the source to target voice transformation. By tailoring a codebook specifically to the source voice and a codebook specifically to the target voice, the accuracy of the transformation is greatly enhanced. However, the use of a custom set of speech frames increases the demands on storage. The elimination of the use of codebooks altogether requires less storage space and less computing power. Especially in an offline process such as dubbing, the quality of the voice conversion can still be preserved without the use of codebooks. Furthermore, the codebook techniques are insufficient in modeling the frame-to-frame variations and the consecutive structure in the speech signal as described above.

### SUMMARY OF THE INVENTION

The present invention overcomes these and other deficiencies of the prior art by providing a method of aligning source and target utterances during the training phase without the need for the use of codebooks. A transformation can be trained by force aligning source and target utterances and subdividing corresponding utterances into frames. Furthermore, the transformation is trained to map corresponding source frames to target frames. Once trained, the transformation can be used to transform a previously untransformed source utterance into a target utterance, having the vocal characteristics of a target speaker.

In an embodiment of the invention, a method of speech conversion comprises the steps of: dividing a source signal into multiple source frames; for each source frame, deriving at least one line spectral frequency (LSF) vector, and mapping the at least one LSF vector to a LSF vector of a respective target frame; and assembling the respective target frames into a target source signal. The step of dividing the source signal comprises the step of recognizing phonemes in the source signal. The source signal comprises speech of a person, and the step of recognizing phonemes is performed independently of a particular language and speaker of the speech. The multiple source frames comprises a single phoneme. The step of deriving at least one LSF vector comprises the step of deriving at least one Hidden Markov Model (HMM) state of a source frame. The mapping is performed without the implementation of a codebook. Moreover, the method may further includes the steps of applying a phoneme recognizer to speech of a source speaker and speech of a target speaker for the same template sentence, dividing the speech of the speech of a target speaker into target frames, and force aligning the source frames to the target frames, wherein the source and target frames each comprise only a single phoneme. The source signal comprises speech from a source speaker and the target source signal includes vocal characteristics of a target speaker.

In another embodiment of the invention, a method of speech conversion comprises steps of: training a source to target frame transformation using a source training set of source utterances and a target training set of target utterances that transforms frames with vocal characteristics of the source speaker to frames with vocal characteristics of the target speaker; recognizing phonemes in a source utterance spoken by a source speaker having vocal source speaker vocal characteristics; subdividing the source utterance into at least one source frames comprising only one phoneme; transforming each of the at least one source frame into a target frame based on a source to target frame transformation that transforms frames with vocal characteristics of the source speaker to frames with vocal characteristics of the target speaker; and assembling the target frames transformed from each of the at least one source frame into a target utterance. The step of recognizing phonemes further comprises the step of training a phonemic recognizer.

In yet another embodiment of the invention, a system for speech conversion comprises: a processor; a communication bus coupled to the processor; a main memory coupled to the communication bus; an audio input coupled to the communication bus; an audio output coupled to the communication bus; wherein the processor receives a source utterance spoken by a source speaker having source speaker vocal characteristics from the audio input; the processor receives instructions from the main memory which causes the processor to: recognize phonemes in a source utterance spoken by a source speaker having vocal source speaker vocal characteristics; subdivide the source utterance into at least one source frames comprising only one phoneme; transform each of the at least one source frame into a target frame based on a frame transformation that transforms frames with vocal characteristics of the source speaker to frames with vocal characteristics of the target speaker; and assemble the target frames transformed from each of the at least one source frame into a target utterance.

In yet another embodiment of the invention, a method of creating a dubbed soundtrack, the method comprising the steps: receiving a first soundtrack comprising a first vocal track of a first speaker's speech, wherein the first vocal track includes vocal characteristics of the first speaker's speech; receiving a second soundtrack comprising a second vocal track of a second speaker's speech, wherein the second vocal track includes vocal characteristics of the second speaker's speech; and converting the second soundtrack into a dubbed soundtrack, wherein the dubbed soundtrack includes a third vocal track of the second speaker's speech, wherein the third vocal track includes vocal characteristics of the first speaker's speech. In an embodiment of the invention, the first vocal speaker's speech is in one language and the second vocal speaker's speech is in a different language.

The foregoing, and other features and advantages of the invention, will be apparent from the following, more particular description of the embodiments of the invention, the accompanying drawings, and the claims.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a conventional technique for dubbing an English language movie into Spanish;

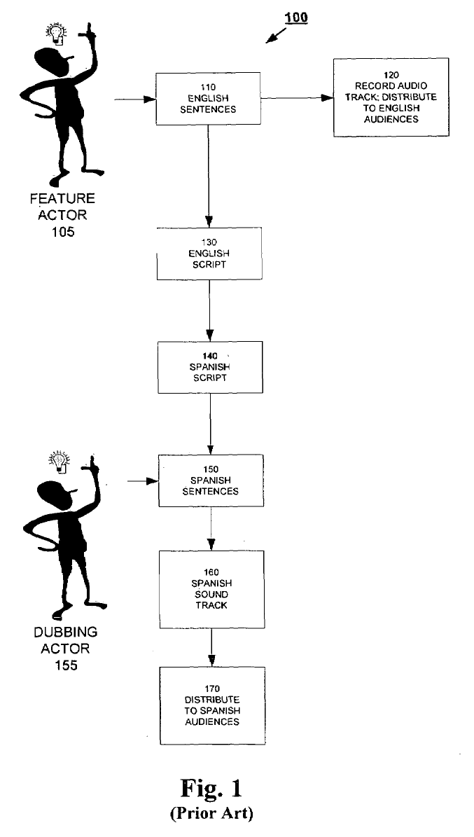

FIG. 2 illustrates a conventional speech conversion system employing a standard codebook;

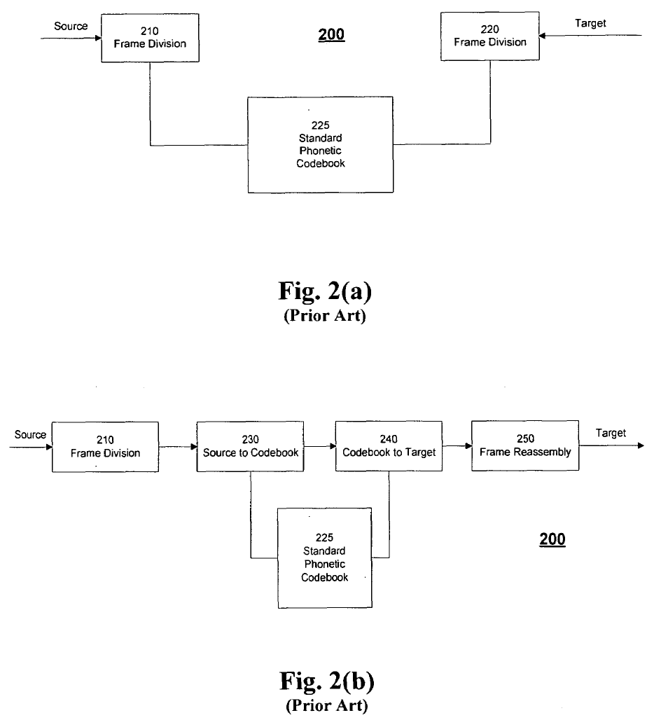

FIG. 3 illustrates a conventional speech conversion system employing source and target codebooks;

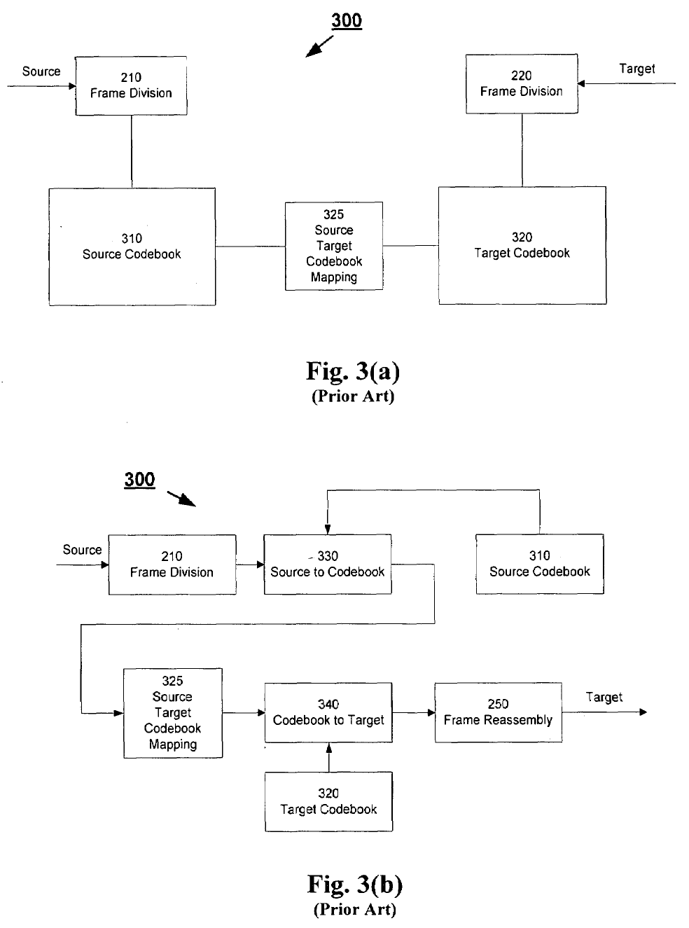

FIG. 4 illustrates a system for dubbing an English language movie into Spanish according to an embodiment of the invention.

FIG. 5 illustrates a speech conversion system according to an embodiment of the invention; and

FIG. 6 illustrates a process implemented by an adaptive algorithm according to an embodiment of the invention.

### DETAILED DESCRIPTION OF THE EMBODIMENTS

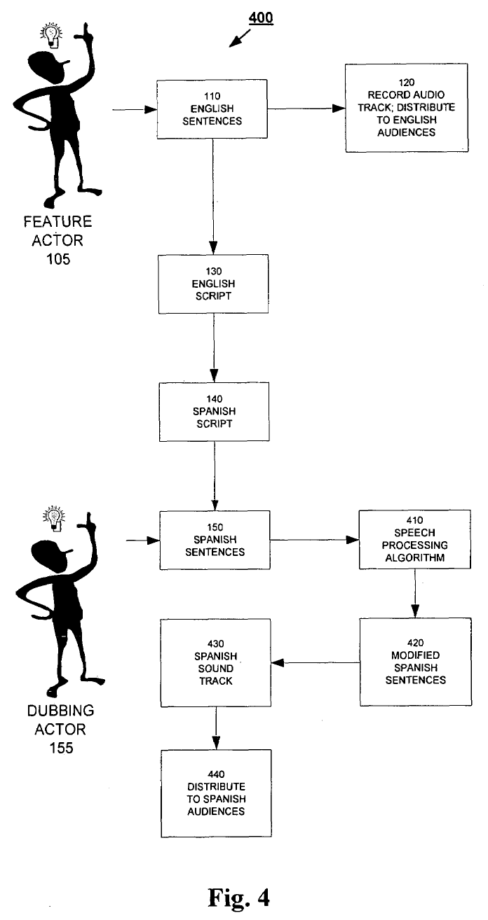

Further features and advantages of the invention, as well as the structure and operation of various embodiments of the invention, are described in detail below with reference to the accompanying FIGS. 4-6, wherein like reference numerals refer to like elements. The embodiments of the invention are described in the context of movie dubbing. However, one of ordinary skill in the art readily recognizes that the invention also has utility in any application that employs speech conversion.

FIG. 4 illustrates a system 400 for dubbing an English language movie into Spanish according to an embodiment of the invention. Here, the system 400 provides a phonetic mapping between speech from a feature actor 105 and a dubbing actor 155. Particularly, Spanish sentences 150 spoken by the dubbing actor 155 are electronically processed by an algorithm 410, which is described in enabling detail below, and transformed into modified Spanish sentences 420. The modified sentences 420 are in Spanish, but have vocal characteristics substantially identical to the voice of feature actor 105 and not dubbing actor 155. The modified sentences 420 are included in a Spanish sound track 430. This new dubbed sound track 430 can then be superimposed on the sound track of the original movie to generate a dubbed movie 440 that can be distributed to Spanish audiences.

In the following discussion, the voice of the feature actor 105 corresponds to the “target” speaker or voice, and the dubbing actor 155 corresponds to the “source” speaker or voice.

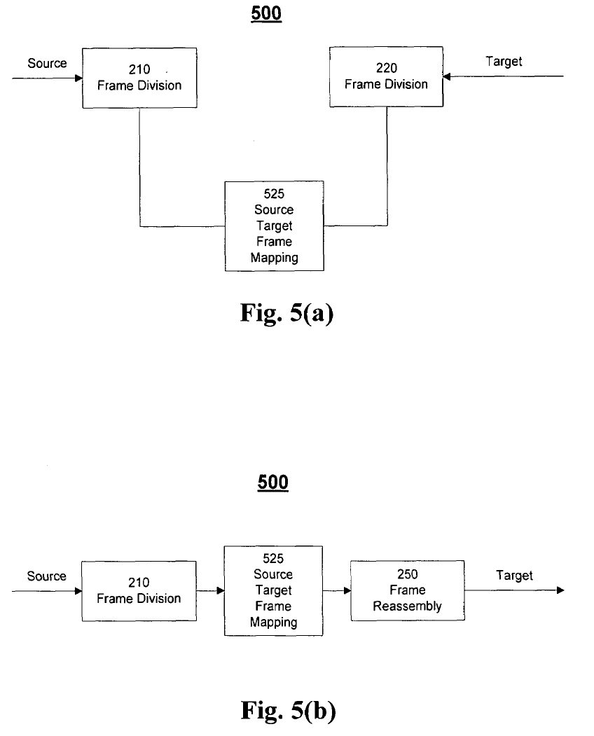

FIG. 5 illustrates a speech conversion system 500 according to an embodiment of the invention. Referring to FIG. 5(a), which shows the training phase, source and target utterances of the same sentences are broken up into frames by frame divider hardware/software 210. The frames are fed into a source target frame mapping 525, which “learns” the mapping between the source frames and the target frames.

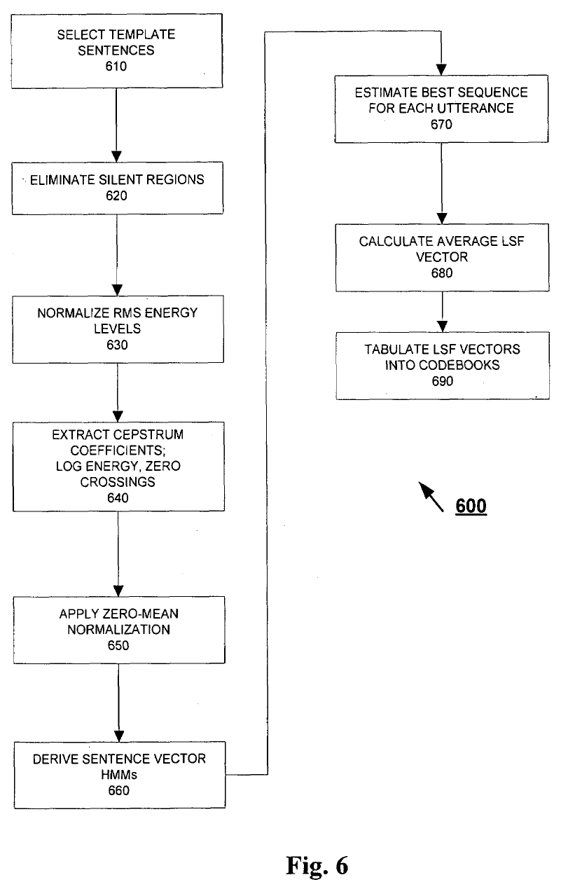

More specifically, adaptive algorithm 410 develops the mapping 525 between source frames and target frames according to the process illustrated in as shown in FIG. 6. First, a speaker independent phoneme recognizer is applied (step 610) to both the source speaker utterance and the target speaker utterance of the same template sentence. In a preferred embodiment, the utterances are subdivided so that each frame comprises a single phoneme. The frames for the source utterance and the target utterance are then force aligned. Once the boundaries of the phonemes are determined, the source frame locations and corresponding target frame locations within each phoneme are found using linear interpolation.

The force alignment not only eliminates the need for a transcription of the training utterances, but has advantages over the use of a transcription. For example, suppose the training utterance contains the word “cats” (phonemically /k/ /ae/ /t/ /s/). Suppose the phonemic recognizer recognizes the word as /k/ /ae/ /p/ /s/, which is slightly inaccurate. Because it is normal for a mathematical model such as a phonemic recognizer to repeat similar errors in similar situations, the phonemic recognizer could also recognize the target utterance /k/ /ae/ /p/ /s/, while also inaccurate is inaccurate in the same way resulting in a more accurate alignment than a true transcription.

In an embodiment of the invention, the speaker independent phoneme recognizer is also a language independent phoneme recognizer. A preexisting recognizer can be used or a phoneme recognizer could be trained as part of the system. In the latter case, the phoneme recognizer is trained using sufficient training samples to represent the language and potential speakers. The number of “sufficient” samples is readily apparent to one of ordinary skill in the art.

Upon segmentation, the frames are prepared for the training portion of process 600. Particularly, silence regions at the beginning and end of each frame are first removed (step 620). For example, an end-point detection technique, the implementation of which is apparent to one of ordinary skill in the art, is employed to remove silences from the beginning and end of source and target frames. Each frame is then scaled, preprocessed, or otherwise adjusted to eliminate errors. For example, each frame is normalized (step 630) in terms of its RMS energy to account for differences in the recording gain level. Next, spectrum coefficients are extracted (step 640) along with log-energy and zero-crossing for each analysis frame in an utterance. Zero-mean normalization is preferably applied (step 650) to the parameter vector in order to obtain a more robust spectral estimate. Optionally, based on the parameter vector sequences, sentence HMMs are derived (step 660) for each template sentence using data from the source speaker 155. The number of states for each sentence vector HMM is set proportional to the duration of the utterance.

In an embodiment of the invention, training is performed by employing a segmental k-means algorithm followed by a Baum-Welch algorithm, the implementation of which is apparent to one of ordinary skill in the art. The initial covariance matrix is estimated over the complete training dataset and is not necessarily updated during the training since the amount of data corresponding to each state is generally not sufficient to make a reliable estimate of the variance. The best state sequence for each utterance is estimated (step 670) using a Viterbi algorithm, the implementation of which is apparent to one of ordinary skill in the art.

The average Line Spectral Frequency (LSF) vector for each state is calculated (step 680) for both source and target speakers using frame vectors corresponding to that state index. Finally, these average LSF vectors for each sentence are collected (step 690) to build the mapping 525 between source and target states. Alternatively, all frame LSF vectors may be used without any averaging. In that case, the corresponding source and target frames are found by linear interpolation within each state.

Referring to FIG. 5(b), in the transformation phase, the source signal is subdivided into frames using frame divider hardware/software 210 implementing a phoneme recognizer. The source frame is reconditioned and Hidden Markov Model (HMM) states are derived for the source frame, according to the process 600, resulting in a set of LSF vectors of each source state corresponding to the frame. Based on the mapping 525 at step 690, these vectors are mapped to an LSF vector of a target source state, which is acoustically realized as a target frame. Finally, the transformed target frames are then reassembled into a target utterance using the frame assembler 250.

In another embodiment, transformation and pitch scaling are separated into separate steps. First, a source utterance is converted to a transformed utterance which resembles the vocal characteristics of the target speaker, but at a pitch similar to that of the source speaker. A pitch scaling algorithm can then be used to scale the pitch to be similar to that of the target speaker. By removing pitch considerations from the transformation phase described above, system 500 can focus on other vocal characteristics other than pitch. For the pitch conversion, either a time-domain pitch-synchronous overlap and add (PSOLA) pitch scaling or a frequency-domain PSOLA pitch scaling can be used. Both of which are well-known in the art. However, while frequency-domain PSOLA pitch scaling has often been used in codebook voice conversion systems, the quality suffers when the scaling ratio is less than 1. Therefore, when scaling ratio is less than 1 a time-domain PSOLA pitch scaling algorithm can be used.

This present invention produces a more accurate conversion and reduces the need for codebooks, but can require more computing capabilities in training the phoneme recognizer, training the source to target transformation, and to perform the transformation itself.

Other embodiments and uses of the invention will be apparent to those skilled in the art from consideration of the specification and practice of the invention disclosed herein. Although the invention has been particularly shown and described with reference to several preferred embodiments thereof, it will be understood by those skilled in the art that various changes in form and details may be made therein without departing from the spirit and scope of the invention as defined in the appended claims.

We claim:

1. A method of speech conversion comprising the steps of:
dividing a source signal into multiple source frames;
for each source frame,
deriving at least one line spectral frequency (LSF) vector, and
mapping said at least one LSF vector to a LSF vector of a respective target frame; and
assembling said respective target frames into a target source signal.

2. The method of claim 1, wherein said step of dividing said source signal comprises the step of recognizing phonemes in said source signal.

3. The method of claim 2, wherein said source signal comprises speech of a person, and
said step of recognizing phonemes is performed independent of a particular language and speaker of said speech.

4. The method of claim 1, wherein at least one of said multiple source frames comprises a single phoneme.

5. The method of claim 1, wherein said step of deriving at least one LSF vector comprises the step of deriving at least one Hidden Markov Model (HMM) state of a source frame.

6. The method of claim 1, wherein said mapping is performed without the implementation of a codebook.

7. The method of claim 1, further comprising the steps of:
applying a phoneme recognizer to speech of a source speaker and speech of a target speaker for the same template sentence,
dividing said speech of said speech of a target speaker into target frames, and
force aligning said source frames to said target frames.

8. The method of claim 7, wherein said source and target frames each comprise only a single phoneme.

9. The method of claim 1, wherein said source signal comprises speech from a source speaker and said target source signal includes vocal characteristics of a target speaker.

10. A method of speech conversion comprising the steps of:
training a source to target frame transformation using a source training set of source utterances and a target training set of target utterances that transforms frames with vocal characteristics of the source speaker to frames with vocal characteristics of the target speaker;
recognizing phonemes in a source utterance spoken by a source speaker having vocal source speaker vocal characteristics;
subdividing the source utterance into at least one source frames comprising only one phoneme;
transforming each of said at least one source frame into a target frame based on a source to target frame transformation that transforms frames with vocal characteristics of the source speaker to frames with vocal characteristics of the target speaker; and
assembling the target frames transformed from each of said at least one source frame into a target utterance.

11. The method of claim 10, said step of recognizing phonemes further comprises the step of training a phonemic recognizer.

12. A system for speech conversion comprising:
a processor;
a communication bus coupled to the processor;
a main memory coupled to the communication bus;
an audio input coupled to the communication bus;
an audio output coupled to the communication bus;
wherein the processor receives a source utterance spoken by a source speaker having source speaker vocal characteristics from the audio input; the processor receives instructions from the main memory which causes the processor to:
recognize phonemes in a source utterance spoken by a source speaker having vocal source speaker vocal characteristics;
subdivide the source utterance into at least one source frames comprising only one phoneme;
transform each of said at least one source frame into a target frame based on a frame transformation that transforms frames with vocal characteristics of the source speaker to frames with vocal characteristics of the target speaker; and
assemble the target frames transformed from each of said at least one source frame into a target utterance.

13. A method of creating a dubbed soundtrack, the method comprising the steps:
receiving a first soundtrack comprising a first vocal track of a first speaker's speech, wherein said first vocal track includes vocal characteristics of said first speaker's speech;
receiving a second soundtrack comprising a second vocal track of a second speaker's speech, wherein said second vocal track includes vocal characteristics of said second speaker's speech; and
converting said second soundtrack into a dubbed soundtrack, wherein said dubbed soundtrack includes a third vocal track of said second speaker's speech, wherein said third vocal track includes vocal characteristics of said first speaker's speech.

14. The method of claim 13, wherein said first vocal speaker's speech is in one language and said second vocal speaker's speech is in a different language.
